(19) United States
(12) Patent Application Publication
(10) Pub. No.: US 2021/0176612 A1
(43) Pub. Date: Jun. 10, 2021

(54) SHORT-RANGE COMMUNICATION SYSTEM AND METHOD THEREOF

(71) Applicant: NANNING FUGUI PRECISION INDUSTRIAL CO., LTD., Nanning (CN)

(72) Inventor: CHE-MING KUO, New Taipei (TW)

(21) Appl. No.: 16/705,393

(22) Filed: Dec. 6, 2019

(51) Int. Cl. H04W 4/46; H04W 4/02; G06K 9/00; H04W 4/80

(52) U.S. Cl. CPC H04W 4/46; H04W 4/023; G06K 2209/15; H04W 4/80; G06K 2209/21; G06K 9/00791

(57) ABSTRACT

A short-range communication system includes an image capturing module, a processing unit, and a wireless communication module. The image capturing module captures a first image having a first target, a first identification code of the first target, and at least a portion of a second target. The processing unit calculates a relative position between the first target and the second target based on the first image. The wireless communication module communicates with the first target according to the first identification code to output the relative position to the first target, receives a second identification code of the second target from the first target, and communicates with the second target according to the second identification code.

### FIELD

The application relates in general to a short-range communication system and a short-range communication method, and in particular to the short-range communication system and the short-range communication method of exchanging data with a target according to an identification code of the target.

### REARGROUND

With the development of the vehicle industry, the control of vehicles has gradually evolved from human drivers to autonomous driving. When the vehicle is driven by a human driver, the driver usually uses the horn to alert other vehicles. However, when there are multiple vehicles or in special circumstances, a simple horn sound usually cannot accurately pass the correct information. Therefore, a system capable of accurately transmitting complex information content to the correct target is desired.

### BRIEF DESCRIPTION OF THE DRAWINGS

Implementations of the present disclosure will now be described with reference to the attached figures.

FIG. 1 is a block diagram of a short-range communication system in accordance with an embodiment of the present disclosure;

FIG. 2 is a schematic diagram of relative position between the short-range communication system and surrounding targets in accordance with an embodiment of the present disclosure;

FIG. 3 is a flow chart of a short-range communication method in accordance with an embodiment of the present disclosure.

### DETAILED DESCRIPTION

Further areas to which the present disclosure can be applied will become apparent from the detailed description provided herein. It should be understood that the detailed description and specific examples, while indicating exemplary embodiments, are intended for purposes of illustration only and are not intended to limit the scope of the claims.

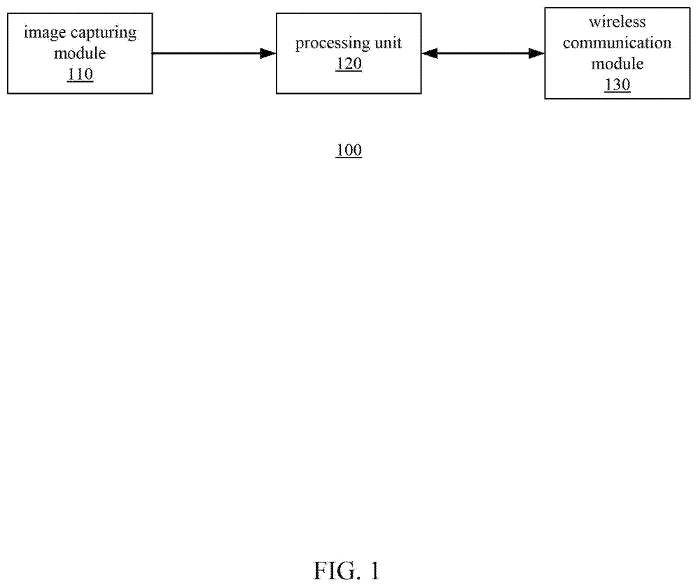

FIG. 1 is a block diagram of a short-range communication system in accordance with an embodiment of the present disclosure. In some embodiments of the present invention, the short-range communication system 100 communicates with at least one target (e.g., a vehicle) within a predetermined communication range. The short-range communication system 100 includes at least an image capturing module 110, a processing unit 120, and a wireless communication module 130. The image capturing module 110 is composed of at least one lens, and obtains images within lens coverage every predetermined time. In general, when the communication target is the vehicle, the identification code is usually be license plate numbers, and since most of the license plates are disposed on at least one of a front side and a rear side of the vehicle, the image capturing module 110 generally faces towards the front side and the rear side, which means the image capture module 110 can be disposed at the front side and the rear side of the vehicle to capture the images of other targets having the identification code. The processing unit 120 receives the images from the image capturing module 110, calculates a relative position (including a distance and an orientation) between other objects and the short-range communication system 100 itself, and determines whether each target has its own identification code. The processing unit 120 can be implemented in various manners, such as dedicated hardware circuits or general-purpose hardware (e.g., a single processor, a multi-processor with parallel processing capability, a graphics processor, or other processor with computing power), and when the program code or software is executed, the functions as described below are provided. The wireless communication module 130 connects to the processing unit 120 and can be a dedicated short-range communications (DSRC) for communicating with other targets within the predetermined communication range through vehicle-to-vehicle (V2V) and ultra-wideband (UWB), or other short-range communication technologies. The wireless communication module 130 connects to the wireless communication module of each target through its own identification code. For example, in an embodiment of the present invention, when the target is the vehicle, the processing unit 120 enables the wireless communication module 130 to communicate with the other vehicle based on the license plate numbers.

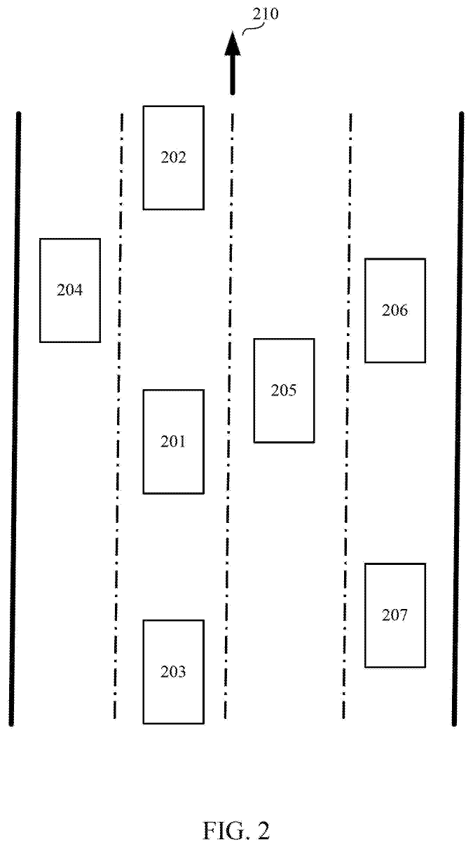

FIG. 2 is a schematic diagram of relative position between the short-range communication system and surrounding targets in accordance with an embodiment of the present disclosure. In this embodiment, both the moving object 201 and the targets 202-207 are the vehicles, and the front ends of the vehicles—all travel in the direction of an arrow 210. The moving object 201 is provided with the short-distance communication system 100, at the front side and the rear side of the moving object 201 are provided with the image capturing module 110 (hereinafter referred as a front side module and a rear side module, respectively), and the license plate of each target 202-207 is also disposed on the front side and the rear side of themselves, and all of target 202-207 are provided with the wireless communication module. In this embodiment, the targets 202-207 are all located within the predetermined communication range of the wireless communication module 130 of the moving object 201. According to the relative position in FIG. 2, the front side module of the moving object 201 may obtains a first image of the target 202, 204 having the rear-side license plate numbers and the target 205 without the complete license plate numbers. The rear side module of the moving object 201 may obtains a second image of the target 203 having the complete front-side license plate numbers and the target 207 without the complete license plate numbers. The processing unit 120 then performs image processing related to license plate recognition to analyze the license plate numbers of the targets 202-207 in the first image and the second image, calculates the relative position between the targets 202-207 and the moving object 201, and displays the license plate numbers on a display screen of the driver's seat for the driver. For example, when the driver touches on the license plate number of the target 202 on the display screen to have voice communication, the processing unit 120 enables the wireless communication module 130 to communicate with the target 202 according to a touch signal. In addition, the relative position between the moving object 201 and the surrounding targets can be directly displayed on the display screen. When the driver selects one of the targets, the processing unit 120 searches for the corresponding license plate numbers according to the relative position between the selected target and the moving object 201

However, when the driver wants to communicate with the targets 205, 207 having without the complete license plate numbers, the complete license plate numbers of the targets 205, 207 must be obtained through the targets 202, 203, respectively. In order to obtain the license plate numbers of the target 205 from the image captured by the target 202, the processing unit 120 calculates the relative position between the target 202 and the target 205 according to the relative position between the moving object 201 and the targets 202 and 205, respectively. For example, in this embodiment, the target 202 is located directly in front of the moving object 201, the target 205 is located in the right front of the moving object 201, and the target 202 is further away from the moving object 201 than the target 205, so that the target 205 is located in the right rear of the target 202. Next, the moving object 201 sends a communication request to the target 202 to ask for the front-side license plate numbers of the target 205 in the rear image obtained by the target 202. The target 202 also obtains the front-side license plate numbers of the target 205 through image processing related to license plate recognition. Finally, the target 202 replies the license plate numbers of the target 205 to the moving object 201 such that the processing unit 120 of the moving object 201 can enable the wireless communication module 130 to communicate with the target 205 based on the license plate numbers. It should be noted that the flow of obtaining the license plate numbers of the target 207 is the same as the target 205, and it will not be described herein to simplify the explanation.

In the embodiment of the present invention, when the moving object 201 needs to communicate with the target 205, the wireless communication module 130 of the moving object 201 first outputs a communication request to the target 205 through the predetermined communication channel. After receiving the communication request, if the target 205 is able to exchange data with the moving object 201, the target 205 replies a confirmation request corresponding to the communication request to the wireless communication module 130 of the moving object 201. After receiving the confirmation request, the processing unit 120 of the moving object 201 finds a communication channel which is unused and outputs another exchange request to the target 205 to invite the target 205 to exchange data through the communication channel which is unused. It should be noted that the predetermined communication channel is simultaneously monitored by the moving object 201 and the other targets 202-207, and if any of the moving object 201 and the targets 202-207 receives the communication request, they also used the same communication channel to transmit the confirm request.

According to another embodiment of the present invention, the processing unit 120 of the moving object 201 and the targets 202-207 further determines whether to perform subsequent data exchange or not according to the signal strength of the received communication request. For example, when the signal strength is less than a predetermined threshold, the processing unit 120 determines that the moving object 201 or the targets 202-207 corresponding to the communication request are already outside the predetermined communication range, thus the processing unit 120 selectively ignores the communication request. The predetermined threshold may be related to the predetermined communication range or may be defined by the user.

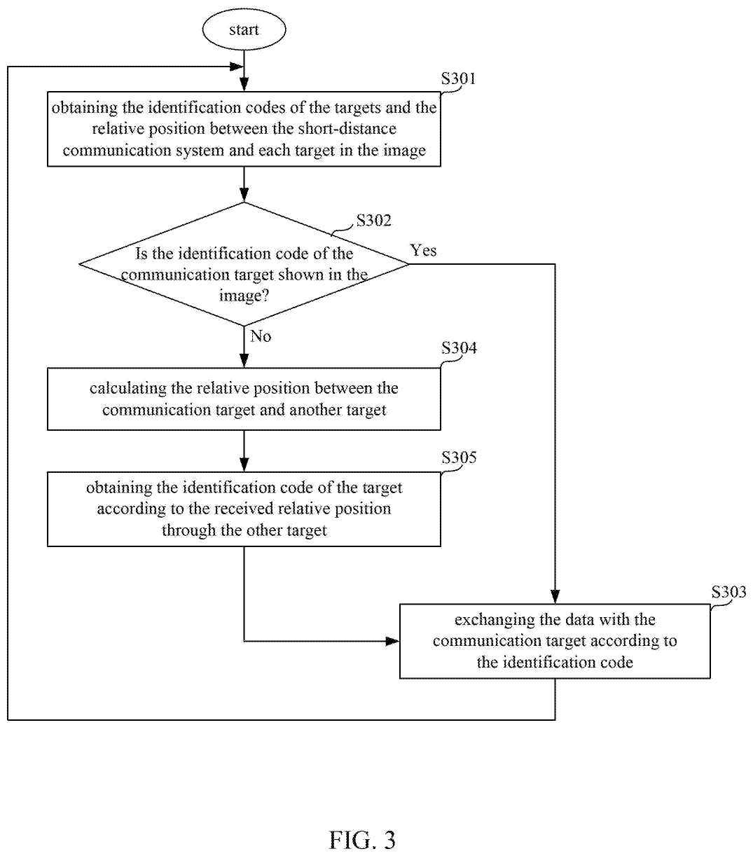

FIG. 3 is a flow chart of a short-range communication in accordance with an embodiment of the present disclosure. First, at step S301, the image capturing module 110 obtains the image around the short-range communication system 100, and the processing unit 120 obtains the identification codes of the targets and the relative position between the short-distance communication system 100 itself and each target in the image. At step S302, the processing unit 120 determines whether the identification code of the communication target is shown in the image. When the target has the identification code, the method proceeds to step S303, the processing unit 120 enables the wireless communication module 130 to output the communication request to the target through the predetermined communication channel according to the identification code, and exchanges the data through another communication channel which is unused according to the confirmation request replied by the communication target. On the other hand, when the processing unit 120 cannot find the identification code corresponding to the communication target in the image captured by the image capturing module 110, the method proceeds to step S304, the processing unit 120 calculates the relative position between the communication target and another target. The relative position between the communication target and the other target is obtained according to the relative position between the communication target and the short-range communication system 100 and the relative position between the other target and the short-range communication system 100. After obtaining the relative position between the communication target and another target, the method proceeds to step S305, the processing unit 120 outputs the relative position to the other target, and obtains the identification code of the target according to the received relative position through the other target. Then, returning to step S303, the processing unit 120 enables the wireless communication module 130 to output the communication request to the communication target through the predetermined communication channel according to the identification code received from the other target, and then exchange the data with the communication target according to the confirmation request through another unused communication channel.

It should be noted that although the method as described above has been described through a series of steps or blocks of a flowchart, the process is not limited to any order of the steps, and some steps may be different from the order of the remaining steps or the remaining steps can be done at the same time. In addition, those skilled in the art should understand that the steps shown in the flowchart are not exclusive, other steps may be included, or one or more steps may be deleted without departing from the scope.

In summary, according to the embodiments of the short-distance communication system and method thereof recited in the present invention, the identification code of the target can be found according to the image obtained by the image capturing module, and the data can be accurately exchanged with the communication target via the communication channel according to the identification code. In addition, in the case that the processing unit of the system cannot obtain the identification code of the communication target, it can indirectly obtain an image with the identification code of the communication target from different angles through another image capturing module of another target to solve the problem of shooting a dead angle. Through the manner as described above, the driver is able to communicate and exchange data with all targets within the established communication range accurately.

It will be apparent to those skilled in the art that various modifications and variations can be made to the structure disclosed without departing from the scope or spirit of the claims. In view of the foregoing, it is intended that the present disclosure covers modifications and variations, provided they fall within the scope of the following claims and their equivalents.

What is claimed is:

1. A short-range communication system, comprising:
an image capturing module adapted for capturing a first image comprising a first target, a first identification code of the first target, and at least a portion of a second target;
a processing unit adapted for calculating a relative position between the first target and the second target based on the first image;
a wireless communication module adapted for communicating with the first target according to the first identification code to output the relative position to the first target, receiving a second identification code of the second target from the first target, and communicating with the second target according to the second identification code.

2. The short-range communication system of claim 1, wherein the first target obtains the second identification code in a second image comprising the second target according to the relative position.

3. The short-range communication system of claim 1, wherein the processing unit obtains a first location of the first target and a second location of the second target based on the first image, and calculates the relative position according to the first location and the second location.

4. The short-range communication system of claim 1, wherein the wireless communication module further outputs a communication request to at least one of the first target and the second target through a predetermined communication channel, and exchanges multimedia data with at least one of the first target and the second target through another communication channel which is unused after receiving a confirmation request corresponding to the communication request from at least one of the first target and the second target.

5. The short-range communication system of claim 4, wherein at least one of the first target and the second target ignores the communication request when a signal strength of the communication request is less than a predetermined threshold.

6. The short-range communication system of claim 1, wherein the first identification code and the second identification code are license plate numbers.

7. The short-range communication system of claim 1, wherein the wireless communication module communicates with at least one of the first target and the second target via Vehicle to Vehicle (V2V) communication or Ultra-wideband (UWB).

8. A short-range communication method, comprising the steps of:
capturing, by an image capturing module, a first image comprising a first target, a first identification code of the first target, and at least a portion of the second target;
calculating, by a processing unit, a relative position between the first target and the second target based on the first image;
communicating, by a wireless communication module, with the first target according to the first identification code to output the relative position to the first target;
receiving, by the wireless communication module, a second identification code of the second target from the first target, and communicating with the second target according to the second identification code.

9. The short-range communication method of claim 8, wherein the first target obtains the second identification code in a second image comprising the second target according to the relative position.

10. The short-range communication method of claim 8, the method of calculating the relative position between the first target and the second target based on the first image further comprising:
obtaining, by the processing unit, a first location of the first target and a second location of the second target based on the first image, and
calculating, by the processing unit, the relative position according to the first location and the second location.

11. The short-range communication method of claim 8, further comprising:
outputting, by the wireless communication module, a communication request to at least one of the first target and the second target through a predetermined communication channel, and
exchanging, by the wireless communication module, multimedia data with at least one of the first target and the second target through another communication channel which is unused after receiving a confirmation request corresponding to the communication request from at least one of the first target and the second target.

12. The short-range communication method of claim 11, wherein at least one of the first target and the second target ignores the communication request when a signal strength of the communication request is less than a predetermined threshold.

13. The short-range communication method of claim 8, wherein the first identification code and the second identification code are license plate numbers.

14. The short-range communication method of claim 8, wherein the wireless communication module communicates with at least one of the first target and the second target via Vehicle to Vehicle (V2V) communication or Ultra-wideband (UWB).
